(19) United States
(12) Patent Application Publication
(10) Pub. No.: US 2007/0237240 A1
(43) Pub. Date: Oct. 11, 2007

(54) Video coding method and apparatus supporting independent parsing

(75) Inventors: Bae-keun Lee, Bucheon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/705,431

(22) Filed: Feb. 13, 2007

Related U.S. Application Data
(60) Provisional application No. 60/789,576, filed on Apr. 6, 2006.

(30) Foreign Application Priority Data
Jun. 8, 2006 (KR) 10-2006-0051588

(51) Int. Cl. H04N 11/02

(52) U.S. Cl. 375/240.24

(57) ABSTRACT

An apparatus and method are provided for independently parsing fine granular scalability (FGS) layers. A video-encoding method according to an exemplary embodiment of the present invention includes a frame-encoding unit which generates at least one quality layer from an input video frame, a coding-pass-selecting unit which selects a coding pass according to a coefficient of a reference block spatially neighboring a current block in order to code a coefficient of the current block included in the quality layer, and a pass-coding unit which losslessly codes the coefficient of the current block according to the selected coding pass.

### CROSS-REFERENCE TO RELATED APPLICATION

This application claims priority from Korean Patent Application No. 10-2006-0051588 filed on Jun. 8, 2006, in the Korean Intellectual Property Office, and U.S. Provisional Patent Application No. 60/789,576 filed on Apr. 6, 2006 in the United States Patent and Trademark Office, the disclosures of which are entirely incorporated herein by reference.

### BACKGROUND OF THE INVENTION

1. Field of the Invention

Apparatuses and methods consistent with the present invention relate to a video compression technology, and more particularly, to for independently parsing fine granular scalability (FGS) layers.

2. Description of the Related Art

Development of communication technologies such as the Internet has led to an increase in video, text and voice communication. However, consumers have not been satisfied with existing text-based communication schemes. To satisfy various consumer needs, services for multimedia data containing text, images, music and the like, have been increasingly provided. However, multimedia data is usually voluminous and requires a large capacity storage medium. Also, a wide bandwidth is required for transmitting the multimedia data. Accordingly, a compression coding scheme is required when transmitting multimedia data.

A basic principle of data compression is to eliminate redundancy in the data. Data can be compressed by removing spatial redundancy, which is the duplication of colors or objects in an image, temporal redundancy, which is little or no variation between adjacent frames in a moving picture or successive repetition of the same sounds in audio, or perceptual-visual redundancy, which considers the limitations of human vision and the inability to hear high frequencies. In general video coding, temporal redundancy can be removed by temporal filtering based on motion compensation, and spatial redundancy can be removed by spatial transformation.

Redundancy-free data is again subjected to quantization (lossy coding) using a predetermined quantization step. The quantized data is finally subjected to entropy coding (lossless coding).

Standardization work for implementation of multilayer-based coding techniques using the H.264 standard is in progress by the Joint Video Team (JVT) of the International Organization for Standardization/International Electrotechnical Commission (ISO/IEC) and the International Telecommunication Union (ITU).

In the Scalable Video Coding (SVC) draft, FGS coding is performed by using the correlation among the respective FGS layers, and not by independently parsing. That is, the method involves coding different FGS layers using the coefficient of a single FGS layer according to the divided coding pass.

If the coefficients of the corresponding base layer (the lowest layer of FGS layers) or the lower layer (the FGS layer beneath a current layer) are 0, the current layer is coded according to a significant pass. If the coefficients of the corresponding base layer or the lower layer are not 0, the current layer is coded according to a refinement pass.

The layer-dependent FGS coding method contributes to the improvement of FGS coding performance by properly using the redundancy of layers. However, the current layer cannot be encoded in the layer-dependent FGS coding before the lower layer is encoded, and the current layer cannot be coded before the lower layer is decoded. Therefore, the FGS coding and encoding process (a parsing process) must be performed in series, which consumes a considerable amount of time to complete, and increases complexity.

Therefore, there exists a need to be able to independently parse a layer without depending on other layers.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for independently parsing quality layers (e.g., FGS layers).

According to an aspect of the present invention, there is provided a video encoder including a frame-encoding unit which generates at least one quality layer from the input video frame, a coding-pass-selecting unit which selects a coding pass according to the coefficient of the reference block spatially neighboring the current block in order to code the coefficient of the current block included in the quality layer, and a pass-coding unit which codes the coefficient of the current block losslessly according to the selected coding pass.

According to another aspect of the present invention, there is provided a video encoder including a frame-encoding unit which generates at least one quality layer from the input video frame, a refinement pass-coding unit which codes the current block included in the quality layer losslessly according to a refinement pass, a significant-pass-coding unit which losslessly codes the current block included in the quality layer according to a significant pass, a cost computing unit which computes the cost of a data losslessly coded according to the refinement pass and the cost of a data losslessly coded according to the significant pass, and a selecting unit which selects the data with the lower computed cost to output it as a bitstream.

According to still another aspect of the present invention, there is provided a video encoder including a frame-encoding unit which generates at least one quality layer from the input video frame, a frequency-group-dividing unit which divides a plurality of blocks included in the quality layer into two or more frequency groups according to a frequency, a scanning unit which scans and collects the coefficients included in the divided frequency groups, and an arithmetic-coding unit which selects a context model of the coefficients for each of the collected frequency group and then arithmetically codes the coefficients for each of the frequency group according to the context model.

According to a further aspect of the present invention, there is provided a video decoder including a coding-pass-selecting unit which selects the coding pass according to the coefficient of the reference blocks spatially neighboring to the current block in order to decode the coefficient of the current blocks included in at least one quality layer contained in the input bitstream, a pass-coding unit which codes the coefficient of the current block losslessly according to the selected coding pass, and a frame-decoding unit which restores an image of the current block from the coefficient of the losslessly-coded current block.

According to yet another aspect of the present invention, there is provided a video decoder including a flag-reading unit which reads a flag in order to decode the coefficient of the current block included in at least one quality layer contained in the input bitstream, a pass-coding unit which codes the coefficient of the current block losslessly according to the coding pass directed by the read flag, and a frame-decoding unit which restores an image of the current block from the coefficient of the losslessly-coded current block.

According to another aspect of the present invention, there is provided a video decoder including a flag-reading unit which reads a flag in order to decode the coefficient for a plurality of frequency groups contained in the input bitstream, an arithmetic-decoding unit which selects context models for each frequency group directed by the read flag and then arithmetically decodes the coefficients for each of the frequency group according to the selected context models, and a inverse-scanning unit which inversely arranges the arithmetically-decoded coefficients into the value with respect to the respective blocks.

### BRIEF DESCRIPTION OF THE DRAWINGS

The above and other aspects of the present invention will become more apparent by describing in detail exemplary embodiments thereof with reference to the attached drawings, in which:

FIG. 1 illustrates an example of a plurality of quality layers forming a single slice;

FIG. 2 illustrates an example of a process of expressing a single slice as a base layer and two FGS layers;

FIG. 3 illustrates a method of determining a coding pass based on a 4×4 block according to an exemplary embodiment of the present invention;

FIG. 4 illustrates a method of determining a coding pass based on a macroblock according to an exemplary embodiment of the present invention;

FIG. 5 illustrates the coefficients with similar frequency in a 4×4 block existing in an FGS layer according to an exemplary embodiment of the present invention;

FIG. 6 illustrates an example of dividing the 4×4 block into three groups;

FIG. 7 illustrates an example of applying group division of FIG. 6 to an entire macroblock;

FIG. 8 illustrates an example of a zig-zag scanning method which can be applied to the respective divided groups;

FIG. 9 illustrates a method of arranging the divided group into a bitstream in order of significance;

FIG. 10 is a block diagram illustrating a configuration of a video encoder according to an exemplary embodiment of the present invention;

FIG. 11 is a block diagram illustrating an exemplary embodiment of a detailed configuration of an entropy-coding unit corresponding to a solution 1;

FIG. 12 is a block diagram illustrating an exemplary embodiment of a detailed configuration of an entropy-encoding unit corresponding to a solution 2;

FIG. 13 is a block diagram illustrating an exemplary embodiment of a detailed configuration of an entropy-encoding unit corresponding to a solution 3;

FIG. 14 is a block diagram illustrating a configuration of a video decoder according to an exemplary embodiment of the present invention;

FIG. 15 is a block diagram illustrating an exemplary embodiment of detailed configuration of an entropy-decoding unit corresponding to solution 1;

FIG. 16 is a block diagram illustrating an exemplary embodiment of detailed configuration of an entropy-decoding unit corresponding to solution 2; and

FIG. 17 is a block diagram illustrating an exemplary embodiment of detailed configuration of an entropy-decoding unit corresponding to solution 3.

### DETAILED DESCRIPTION OF THE EXEMPLARY EMBODIMENTS OF THE INVENTION

Advantages and features of the aspects of the present invention and methods of accomplishing the same may be understood more readily by reference to the following detailed description of exemplary embodiments and the accompanying drawings. The aspects of the present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Exemplary embodiments of the present invention will now be described with reference to the drawings.

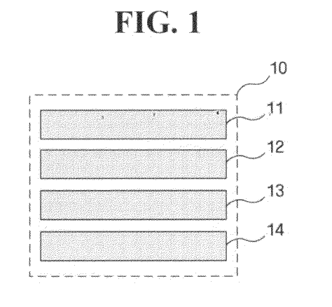

FIG. 1 illustrates an example of a plurality of quality layers 11, 12, 13, 14 forming a single frame or a slice 10 (hereinafter, referred to as a “slice”). A quality layer is data wherein a single slice is divided and recorded in order to support a signal-to-noise ratio (SNR) scalability. The FGS layer is used as an example of the quality layer, but the quality layer is not limited to the FGS layer.

A plurality of quality layers may include a base layer 14 and one or more FGS layers 11, 12, 13. The video picture quality measured in a video decoder is improved according to the order of the following cases; when only the base layer 14 is received, when the base layer 14 and a first FGS layer 13 are received, when the base layer 14, the first FGS layer 13, and a second FGS layer 12 are received, and when all layers 14, 13, 12, 11 are received.

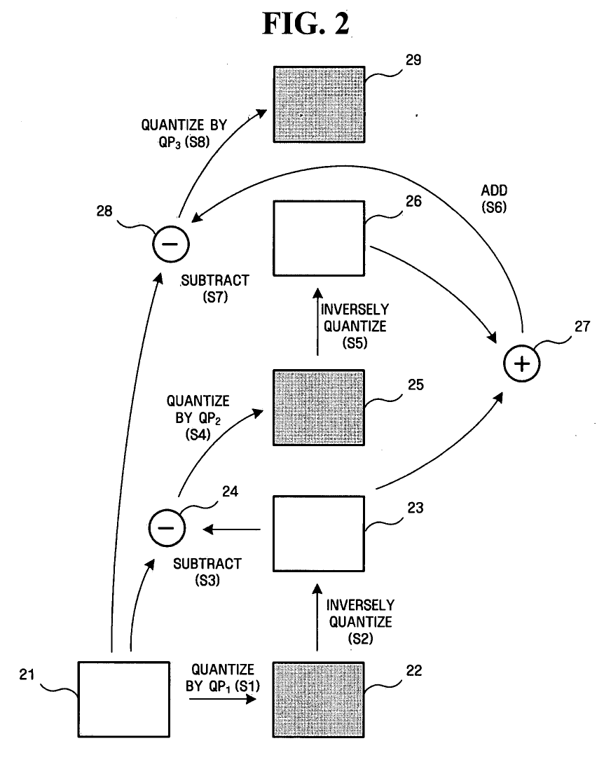

FIG. 2 illustrates a process of expressing a single slice as a base layer and two FGS layers.

The original slice is quantized by a first quantization parameter QP₁ (S1). The quantized slice 22 forms a base layer. The quantized slice 22 is inversely quantized (S2), and it is provided to a subtractor 24. The subtractor 23 subtracts the slice 23 provided by the original slice (S3). The result of the subtraction is quantized again by a second quantization parameter QP₂ (S4). The result of the quantization 25 forms the first FGS layer.

The quantized result 25 is inversely quantized (S5) and the result is added to the quantized picture 23 by an adder 27 (S6), and provided to the subtractor 28. The subtractor 28 subtracts the result of the addition from the original slice (S7). The result of the subtraction is quantized again by a third quantization parameter QP₃ (S8). The result of the quantization 29 forms the second FGS layer. Using the above process, a plurality of quality layers can be made as depicted in FIG. 1.

In order to encode or decode the plurality of quality layers independently, the present invention provides three solutions.

Solution 1

Solution 1 provides an example of a method of separating the coding pass (a significant pass and refinement pass) of the current layer by using the correlation among the coefficients of a spatially neighboring the current layer. The spatial correlation can be compared using the discrete cosine transform (DCT) block size (4×4 or 8×8), or the macroblock size (16×16).

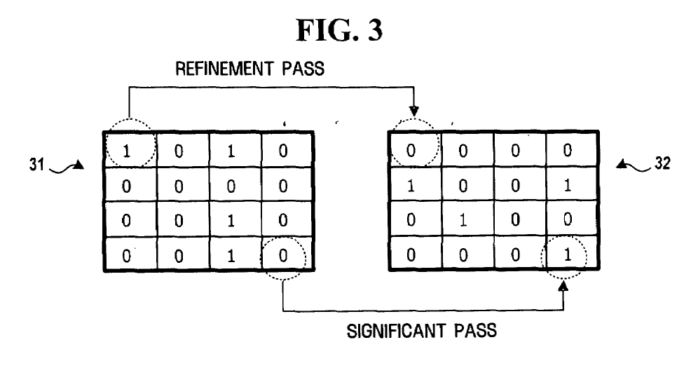

FIG. 3 illustrates a method of determining a coding pass into a 4×4 block unit according to an exemplary embodiment of the present invention.

The coding pass of a certain coefficient (the current coefficients) in the current block 32 is determined according to the value of the coefficients corresponding to the reference block 31 which spatially neighbors the current block 32. If the value of the corresponding coefficient is 1, the current coefficient is coded according to the refinement pass. If the value of the corresponding coefficient is 0, the current coefficient is coded according to the significant pass.

The reference block 31 is a block neighboring the current block 32, and it may correspond to the block neighboring to the left side of the current block 32 (a left block), the block neighboring to an upper boundary of the current block 32 (an upper boundary block), or a virtual block of the representative value of a plurality of neighboring blocks (for example, the median value). Since a right block or a lower boundary block have not been created yet, they cannot be used as reference blocks in coding or decoding of the current block 32.

After determining the coding pass, the coding method, according to the refinement pass or the significant pass, can use the same method used in the conventional SVC standardization.

According to a JVT-P056 document suggested by the current SVC, a coding method is suggested with respect to a significant pass. A code word (that is, the result of the encoding) is characterized by a cut-off parameter “m”. If “C” is less than or equal to “m”, the symbol is encoded using an Exp_Golomb code. If “C” is greater than “m”, it is divided into two parts, a length and a suffix, according to Equation 1:

$$\text{Equation 1:}$$

$$P = ⌊ \frac{C - m}{3} ⌋ + m$$

where “P” is an encoded code word, including a length and a suffix 00, 01, or 10.

In one embodiment, the refinement pass may have a higher possibility of generating a corresponding coefficient that is equal to 0. Therefore, a method of allocating the code words with different length by using a single variable length coding (VLC) table based on the number 0 included in the group of each refinement bits to be coded, is suggested in the JVT-P056. The refinement bit group is a collection of refinement bits in a predetermined number of units. For example, four refinement bits can be regarded as one refinement bit group.

If the movement in the video frames is fast or a video frame includes repetitive images in a wide interval, it may be preferable to determine the coding pass by the DCT block unit, rather than by the macroblock unit used in estimating the movement.

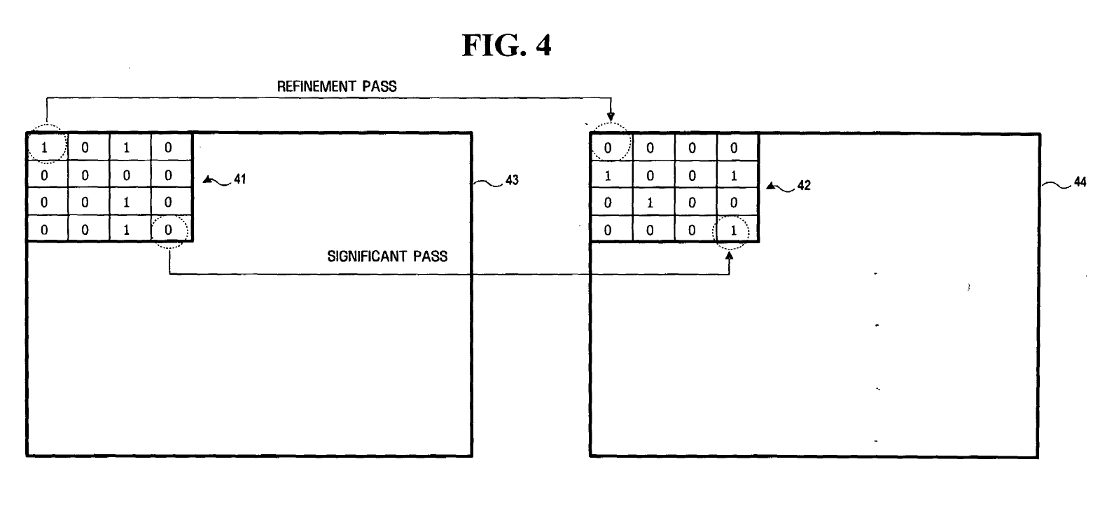

FIG. 4 illustrates a method of determining a coding pass based on a macroblock unit according to an exemplary embodiment of the present invention.

In one exemplary embodiment, a coding pass of a certain coefficient within the current macroblock 44 is determined according to the corresponding coefficient in a reference macroblock 43. That is, if the corresponding coefficient is 1, the current coefficient is coded according to the refinement pass. If the corresponding coefficient is 0, the current coefficient is coded according to the significant pass.

The reference macroblock 43 is a macroblock neighboring the current macroblock 44, and may correspond to the macroblock neighboring the left side of the current macroblock 44, the macroblock neighboring an upper boundary of the current macroblock 44, or a virtual macroblock of the representative value of a plurality of neighboring macroblocks.

The coding method performed according to the refinement pass or the significant pass, after the determination of the coding pass, can use the same method used in the conventional SVC standardization.

Solution 2

Solution 2 provides an example of a method of coding the unit block, the method including comparing the result of the coding according to the refinement pass and the result of the coding according to the significant pass for each unit block (a DCT block, a macroblock, or an optional size block), and then coding the unit block using a more profitable coding pass. According to solution 2, all coefficients within a single unit block are coded by a similar coding pass.

A rate-distortion cost (hereinafter, referred to as the “RD) can be used as a standard for comparing the coded results. The following Equation 2 defines the method of obtaining the rate-distortion cost:

C=E +λ×B, Equation 2

wherein C indicates the cost and E indicates the degree of distortion in an original signal which, for example, may be calculated by a mean square error (MSE). B indicates the bit quantity consumed when compressing the corresponding data, and the λ indicates a Lagrangian multiplier. The Lagrangian multiplier a the coefficient capable of controlling the application ratio of E and B. Therefore, since C decreases as the difference from the original signal E and the consumed bit quantity B decreases, a low C may indicate more efficient coding.

When, with respect to the similar unit block, the cost of coding C according to the refinement pass is expressed as C_{R} and the cost of coding according to the significant pass is expressed as C_{S}, the unit block is coded with a significant pass if the value of C_{R} is greater than the value of C_{S}, and the unit block is coded by a refinement pass if C_{R} is smaller than C_{S}. The determined coding pass is displayed into one bit flag value (coding_pass_flag) and then transmitted to the video decoder side. For example, the flag value indicates a significant pass if the flag value is 1, and the flag value indicates a refinement pass if it is 0.

Solution 3

The block that passed through a DCT process and a quantization process becomes a coefficient in the frequency domain. Since the coefficients have similar features for each frequency, it may be more efficient to divide and group the coefficients for each frequency location and then apply a context adaptive binary arithmetic coding (CABAC) thereto.

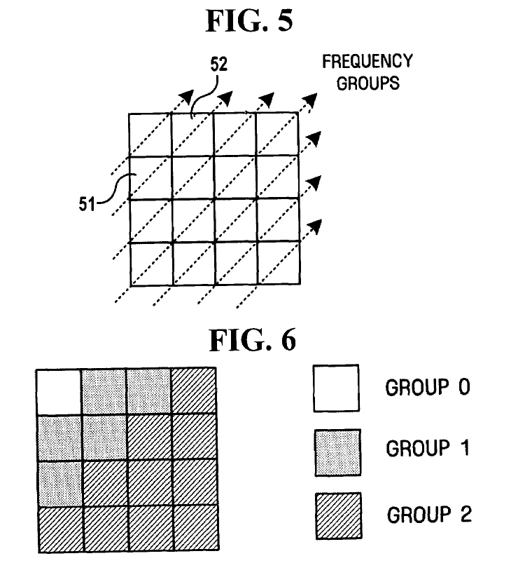

FIG. 5 illustrates the coefficients with similar frequency in a 4×4 block existing on a FGS layer according to an exemplary embodiment of the present invention. Each square represents one coefficient in FIG. 5. As illustrated in FIG. 5, the frequency of the corresponding coefficients is identical in a direction indicated by the diagonal arrow. For example, the coefficient 51 has a frequency similar to that of the coefficient 52. In case of a 4×4 block, the frequency group can be divided from two to seven. A coefficient group having identical frequency in a direction indicated by the arrow is defined as a frequency band.

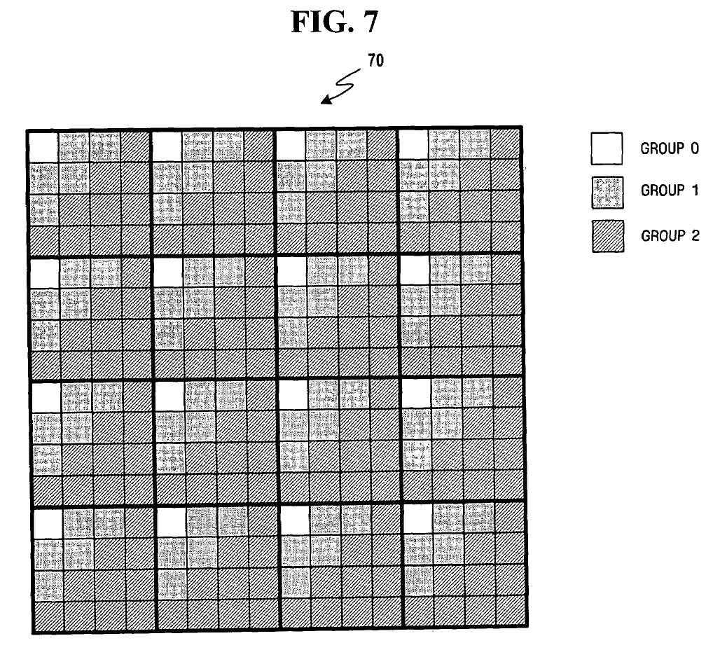

FIG. 6 illustrates an example of dividing the 4×4 block into three groups. Here, group 0 indicates a low frequency area, group 1 indicates a normal frequency area, and group 2 indicates a high frequency area, respectively. Group division is performed in the same manner with respect to an entire macroblock 70, as depicted in FIG. 7. One macroblock 70 is comprised of 16 4×4 blocks. The information about group division is recorded in a predetermined flag (group_partition_flag) and then transmitted to the video decoder.

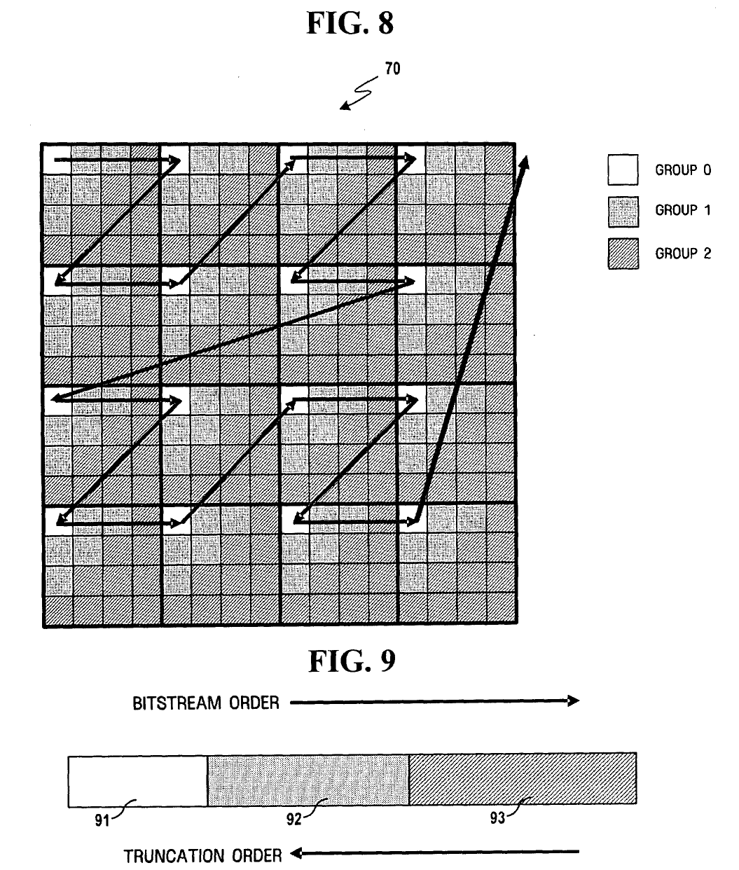

After group division with respect to an entire macroblock has been performed, as depicted in FIG. 7, it is necessary to scan and collect the coefficients corresponding to each group. The scanning method can use various methods such as, for example, a zig-zag scan, a cyclic scan, and a raster scan, but is not limited to these. FIG. 8 illustrates an example of the zig-zag scanning method, used to collect the coefficients of group 0. When the number of the coefficients included in the identical group is plural, the respective coefficients can be collected using the same scanning method.

After collecting the coefficients for each group, using a predetermined scanning method, the bitstreams are configured in an order of significance of each group. That is, the group with the high significance is put in the front of the bit stream and the group with the lowest significance is put in the back. The bitstream may be truncated from the back side to control the SNR. Therefore, the coefficient of a group with relatively low significance can be truncated first.

Generally, low frequency coefficients are more significant than the high frequency coefficients. Therefore, generally, group 0 lies in the front and group 2 lies in the back. However, a component of the high frequency may be more significant than that of the low frequency according to the features of an image. Therefore, the process of determining the significance order among groups 0, 1 and 2 is required.

In one exemplary embodiment, the significance order may be determined according to the rate-distortion cost like the Equation 2. That is, by comparing the cases respectively where some bits of the coefficients in group 0 are truncated, where some bits of the coefficients in group 1 are truncated, and where some bits of the coefficients in group 2 are truncated, the significance order of group where the reduction of the picture quality is great is determined as high.

Meanwhile, after determining the order of the frequency group to be included in the bitstream, as depicted in FIG. 9, the CABAC is performed on each frequency group according to a predetermined context model. The CABAC is an arithmetic coding method performed by selecting the probability model with respect to a predetermined coding object. The CABAC generally includes a binarization, selecting the context model, arithmetically coding and updating the probability.

The binarization is performed when the value to be coded is not a binary value, but a symbol. For example, binarization can be performed by using an Exp-Golomb code word. The context model is a probability model with respect to a bin of one or more binarized symbols, and it is used according to the model selected by the statistics of the recently coded data symbol. The context model stores the probability of each bin when it is 0 or 1. The arithmetic coding is the process of encoding each bin according to the selected context model. Last, the selected context model is renewed on the basis of the actually coded value. For example, if the value of the bin is 1, the probability count of 1 increases.

The context model and the binarization method with respect to each syntax component are already defined in the SVC standardization. Hundreds of independent context models exist with respect to various syntax components. Selecting a context model with respect to each frequency group is left up to the user. The context model defined in the SVC standardization or any other context model may be used. What matters in solution 3 of the present invention is that the coefficients included in different frequency groups may indicate the different probability distribution, and the efficiency of entropy coding may be increased by selecting the proper context model for each of group.

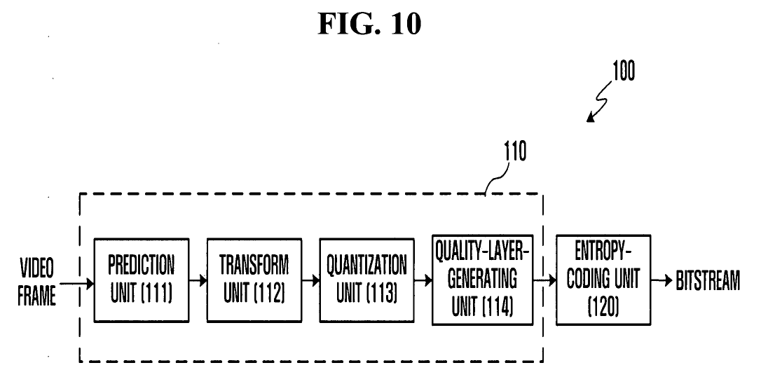

FIG. 10 is a block diagram illustrating a configuration of a video encoder according to an exemplary embodiment of the present invention. The video encoder 100 includes a frame-encoding unit 110 and an entropy-coding unit 120.

The frame-encoding unit 110 generates at least one quality layer with respect to the video frame from the input video frame.

For this, the frame-encoding unit 110 includes a prediction unit 111, a transform unit 112, a quantization unit 113, and a quality-layer-generating unit 114.

The prediction unit 111 subtracts an image predicted using a predetermined prediction technique from a current macroblock to obtain a residual signal. An inter-base-layer prediction and an intra-base prediction can be used for prediction. The inter-base-layer prediction includes a motion estimation process of obtaining a motion vector for expressing the relative movement between the frame having a resolution identical to the current frame and having a different temporal location, and the current frame.

Meanwhile, the current frame can be predicted with reference to the frame of the lower layer (base layer) existing in the temporal location identical to the current frame, and having the resolution different from that of the current frame. This prediction refers to an intra-base prediction. Naturally, the motion prediction process is unnecessary in an intra-base prediction.

A transform unit 112 transforms the residual signal into the transform coefficient using spatial transform methods such as a DCT or a wavelet transform. The transform coefficient is obtained as a result of the spatial transform. When the DCT and the wavelet transform methods are used as the spatial transform methods, a DCT coefficient and a wavelet coefficient are obtained respectively.

A quantization unit 113 quantizes the transform coefficient obtained in the spatial transform unit 1 12 to generate a quantization coefficient. The quantization refers to expressing the transform coefficient having a predetermined real number value by using a discrete value. The quantization method includes a scalar quantization and a vector quantization. The scalar quantization is performed by dividing the transform coefficient into a quantization parameter and then rounding off the result of the division to a nearest integer value.

A quality layer generation unit 114 generates a plurality of quality layers through the process described in FIG. 2. The plurality of quality layers may include a base layer and at least one or more FGS layers. The base layer is independently encoded or decoded, whereas the FGS layer is encoded or decoded with reference to other layers.

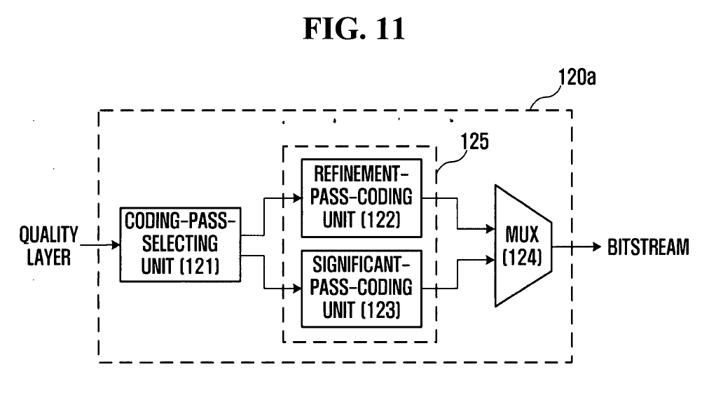

An entropy-coding unit 120 performs independent lossless coding according to an exemplary embodiment of the present invention. Three solutions have been described in the present invention as an detailed example of the lossless coding. FIGS. 11 to 13 illustrate the detailed configuration of the entropy-encoding unit 120 respectively corresponding to solutions 1 to 3.

First, with reference to FIG. 11, an entropy-encoding unit 120a may include a coding-pass-selecting unit 121, a refinement pass-coding unit 122, a significant-pass-coding unit 123, and a multiplexer (MUX) 124.

A coding-pass-selecting unit 121 selects a coding pass (either the refinement or the significant pass) according to the coefficient of the reference blocks spatially neighboring to the current block in order to code the coefficients of the current blocks (4×4 block, 8×8 block, or 16×16 block) included in the quality layers. The reference block may correspond to the block neighboring to the left side or the upper boundary of the current block, or a virtual block generated by the combination of them. The coefficient of the current block and that of the reference block have the same location on a corresponding block, as depicted in FIG. 3 or FIG. 4.

A pass-coding unit 125 losslessly codes the coefficients of the current block according to the selected coding pass. For this, the pass-coding unit 125 includes a refinement pass-coding unit 122 which codes the coefficient of the current block losslessly according to the refinement pass when the coefficient of the reference block is not 0 (1 or more value), and a significant-pass-coding unit 123 which codes the coefficient of the current block losslessly according to the significant pass when the coefficient of the reference block is 0.

A more detailed method of coding by the refinement pass or the significant pass corresponds to the related art, and it has been mentioned in solution 1.

A MUX 124 multiplexes the output of the refinement pass-coding unit 122 and the output of the significant-pass-coding unit 123, and then outputs them as one bitstream.

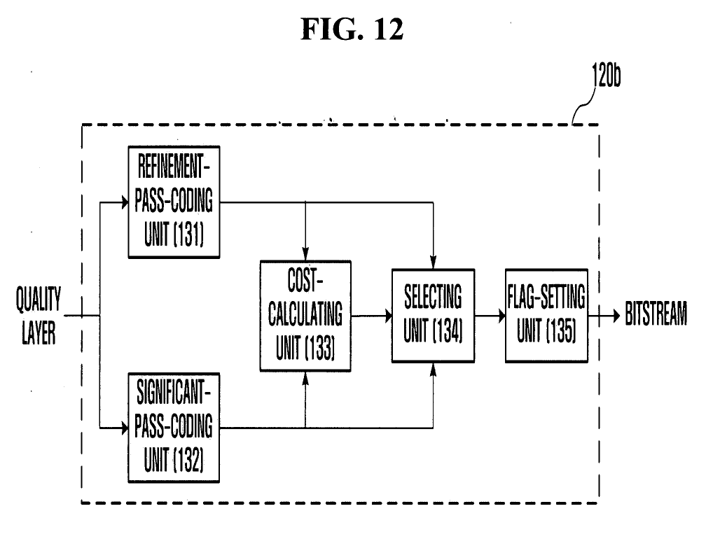

FIG. 12 is a block diagram illustrating an exemplary embodiment of detailed configuration of an entropy-encoding unit 120b corresponding to solution 2. The entropy-encoding unit 120b includes a refinement pass-coding unit 131, a significant-pass-coding unit 132, a cost-calculating unit 133, a selecting unit 134, and a flag-setting unit 135.

A refinement pass-coding unit 131 losslessly codes the current blocks (4×4 block, 8×8 block, or 16×16 block) included in the quality layer according to the refinement pass. Then, the significant-pass-coding unit 132 codes the current block losslessly included in the quality layer according to the significant pass.

A cost-calculating unit 133 calculates the cost of the data losslessly coded according to the refinement pass, and the cost of the data losslessly coded according to the significant pass. The cost can be calculated on the basis of the rate-distortion cost as mentioned in the equation 2.

A selecting unit 134 selects the data which has been coded by the lower pass from among the costs calculated by the cost-calculating unit 133, and then outputs the selected data as a bitstream.

A flag-setting unit 135 records a one bit flag (coding_pass_flag), indicating the data with the lowest calculated cost in the bitstream output by the selecting unit 134.

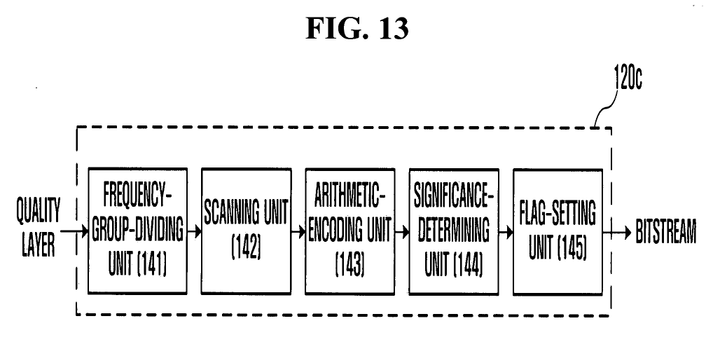

FIG. 13 is a block diagram illustrating an exemplary embodiment of a detailed configuration of an entropy-encoding unit 120c corresponding to solution 3. The entropy-encoding unit 120c includes a frequency-group-dividing unit 141, a scanning unit 142, an arithmetic-encoding unit 143, a significance-determining unit 144, and a flag-setting unit 145.

A frequency-group-dividing unit 141 divides a plurality of blocks included in the quality layer into at least two or more frequency groups according to the frequency. As depicted in FIG. 5, the frequency group illustrates that a plurality of frequency bands formed in a direction indicated by a diagonal arrow on a plurality of blocks are divided into a predetermined number.

A scanning unit 142 collects the coefficients included in the divided frequency groups, with respect to the entire plural blocks. The scanning method may include a zig-zag scan, a cyclic scan, and/or a raster scan.

An arithmetic-encoding unit 143 selects a context model with respect to the coefficients for each of the collected frequency group, and arithmetically codes the coefficients for each of the frequency group according to the context model.

A significance-determining unit 144 determines the significance order of the frequency group by calculating the cost for each frequency group, and arranges the coefficients for each frequency group in a bitstream. The cost can be calculated on the basis of the rate-distortion cost as mentioned in the equation 2.

The frequency group with high significance is arranged in the front of the bitstream. Therefore, when controlling the SNR, the frequency group of relatively low significance may be truncated first.

A flag-setting unit 145 records a group_partition_flag indicating the information about the frequency group division in the bitstream.

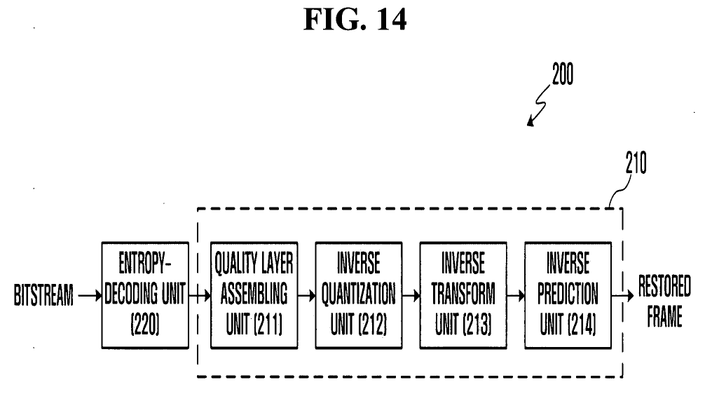

FIG. 14 is a block diagram illustrating a configuration of a video decoder 200 according to an exemplary embodiment of the present invention. The video decoder 200 includes an entropy-decoding unit 220 and a frame-decoding unit 210.

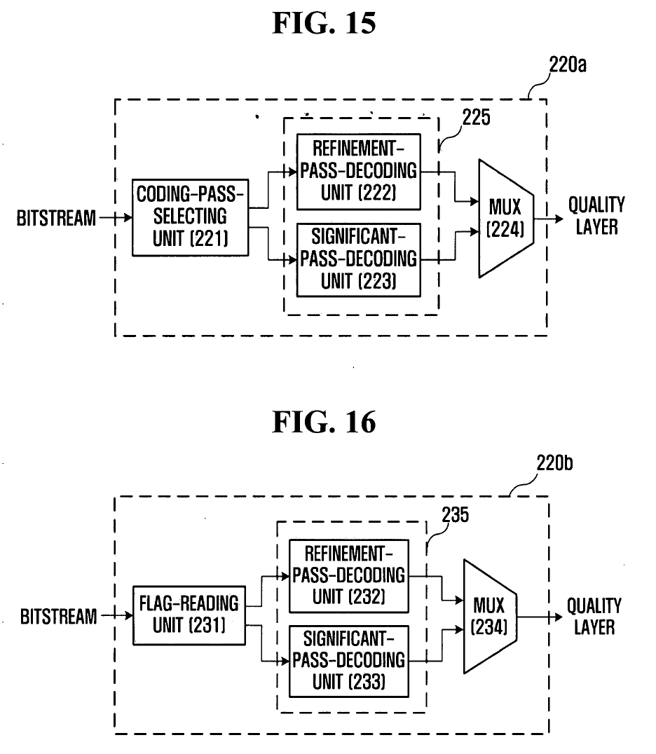

An entropy-decoding unit 220 independently performs lossless decoding on the coefficients included in at least one quality layer contained in the input bitstream. As an example of the lossless decoding, the following FIGS. 15 to 17 illustrate the detailed configuration of an exemplary embodiment of the entropy-decoding unit 220 respectively corresponding to solutions 1 to 3.

A frame-decoding unit 210 restores an image of the current block from the coefficients of the current block losslessly decoded by the entropy-decoding unit 220. For this, the frame-decoding unit 210 includes a quality layer assembling unit 211, a reverse quantization unit 212, a inverse transform unit 213, and a reverse prediction unit 214.

A quality layer assembling unit 211 generates slice data by adding a plurality of quality layers as depicted in FIG. 1 thereto.

A reverse quantization unit 212 inversely quantizes the data provided in the quality layer assembling unit 211.

An inverse transform unit 213 performs a reverse transform on the result of the reverse quantization. The reverse transform is inversely performed against the transform performed in the transform unit 112 in FIG. 10.

The reverse prediction unit 214 adds the restored residual signal provided from the inverse transform unit 213 to restore a video frame. In one exemplary embodiment, the prediction signal can be obtained by an inter-base-layer prediction or an intra-base-layer prediction as done on the video encoder side.

FIGS. 15 to 17 are block diagrams illustrating an exemplary embodiment of detailed configuration of an entropy-decoding unit 220 corresponding to solutions 1 to 3. First, with reference to FIG. 15, the entropy-decoding unit 220a includes a coding-pass-selecting unit 221, a refinement pass-decoding unit 222, a significant pass-decoding unit 223, and a MUX 224.

The coding-pass-selecting unit 221 selects the coding pass (either a refinement pass or a significant pass) according to the coefficient of the reference blocks spatially neighboring the current block in order to decode the coefficient of the current blocks (4×4 block, 8×8 block, or 16×16 block) included in at least one quality layer contained in the input bitstream. The coefficients of the current block and those of the reference block have the same location on the corresponding block.

The pass-decoding unit 225 decodes the coefficient of the current block losslessly according to the selected coding pass. For this, the pass-decoding unit 225 includes a refinement pass-decoding unit 222 which decodes the coefficient of the current block losslessly according to the refinement pass when the coefficient of the reference block is not 0 (1 or more value), and a significant pass-decoding unit 223 which decodes the coefficient of the current block losslessly according to the significant pass when the coefficient of the reference block is 0.

The MUX 224 multiplexes the output of the refinement pass-decoding unit 222 and the output of the significant pass-decoding unit 223, in order to generate a data with respect to a single quality layer.

FIG. 16 is a block diagram illustrating an exemplary embodiment of a detailed configuration of an entropy-decoding unit 220b corresponding to solution 2. The entropy-decoding unit 220b includes a flag-reading unit 231, a refinement pass-decoding unit 232, a significant pass-decoding unit 233, and a MUX 234.

The flag-reading unit 231 reads out a coding_pass_flag to decode the coefficient of the current blocks (4×4 block, 8×8 block, or 16×16 block) included in at least one quality layer contained in the input bitstream.

The pass-decoding unit 235 decodes the coefficient of the current block losslessly according to the coding pass directed by the read flag. The pass-coding unit 235 includes a refinement pass-decoding unit 232 and a significant pass-decoding unit 233, when are similar to those depicted in FIG. 15.

The MUX 234 multiplexes the output of the refinement pass-decoding unit 232 and the output of the significant pass-decoding unit 233, in order to generate data with respect to a single quality layer.

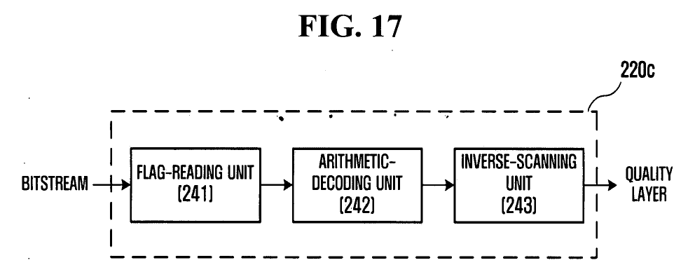

FIG. 17 is a block diagram illustrating an exemplary embodiment of a detailed configuration of an entropy-decoding unit 220c corresponding to solution 3. The entropy-decoding unit 220c includes a flag reading unit 241, an arithmetic-decoding unit 242, and an inverse scanning unit 243.

The flag-reading unit 241 reads a group_partition_flag to decode the coefficients for a plurality of frequency groups included in the input bitstream.

The arithmetic-decoding unit 242 selects a context model for each frequency group directed by the read flag, and then arithmetically decodes the coefficients for each frequency group according to the selected context model. The arithmetic decoding is performed through the decoding process corresponding to CABAC.

The inverse-scanning unit 243 arranges the arithmetically-decoded coefficients into the value on each block (4×4 block, 8×8 block, or 16×16 block). That is, the coefficients collected through the scanning process as depicted in FIG. 8 are inversely arranged into the block units.

The respective components of FIGS. 2 to 6 may be implemented by software or hardware such as a FPGA (Field Programmable Gate Array) or an ASIC (Application Specific Integrated Circuit), and by a combination of the software and hardware. The respective constituent elements may be included in a computer-readable storage medium or parts thereof may be distributed in a plurality of computers. The blocks are combined to form a single quality layer (slice).

In one exemplary embodiment of the present invention, delay of a parsing process can be prevented and complexity of the system can be reduced by independently parsing the respective quality layers.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A video encoder comprising:
a frame-encoding unit which generates at least one quality layer from an input video frame;
a coding-pass-selecting unit which selects a coding pass according to a coefficient of a reference block spatially neighboring a current block in order to code a coefficient of the current block included in the quality layer; and
a pass-coding unit which losslessly codes the coefficient of the current block according to the selected coding pass.

2. The video encoder of claim 1, wherein the coefficient of the current block has the same location as the coefficient of the reference block.

3. The video encoder of claim 1, wherein the quality layer comprises a base layer and at least one fine granular scalability layer.

4. The video encoder of claim 1, wherein the reference block is a block neighboring a left side or an upper boundary of the current block.

5. The video encoder of claim 1, wherein the pass-coding unit comprises:
a refinement-pass-coding unit which losslessly codes the coefficient of the current block according to a refinement pass if the coefficient of the reference block is not 0; and
a significant-pass-coding unit 223 which losslessly codes the coefficient of the current block according to a significant pass if the coefficient of the reference block is 0.

6. The video encoder of claim 1, wherein the current block and the reference block are 4×4 blocks, 8×8 blocks, or 16×16 blocks.

7. A video encoder comprising:
a frame-encoding unit which generates at least one quality layer from an input video frame;
a refinement-pass-coding unit which losslessly codes a current block included in the quality layer according to a refinement pass;
a significant-pass-coding unit which losslessly codes the current block included in the quality layer according to a significant pass;
a cost-calculating unit which calculates a cost of data losslessly coded according to the refinement pass, and a cost of data losslessly coded according to the significant pass; and
a selecting unit which selects one of the data losslessly coded according to the refinement pass and the data losslessly coded according to the significant pass having a lower calculated cost to output as a bitstream.

8. The video encoder of claim 7, wherein the cost calculating unit further comprises a flag-setting unit which records a flag indicating the one of data losslessly coded according to the refinement pass and the data losslessly coded according to the significant pass having the lower calculated cost in the bitstream.

9. The video encoder of claim 7, wherein the current block is a 4×4 block, an 8×8 block, or an 16×16 block.

10. The video encoder of claim 7, further comprising:
a frequency-group-dividing unit which divides a plurality of blocks included in the quality layer into at least two frequency groups according to a frequency;
a scanning unit which scans and collects coefficients included in the frequency groups; and
an arithmetic-coding unit which selects a context model of the coefficients for each of the frequency groups which are scanned and collected and then arithmetically codes the coefficients for each of the frequency groups according to the context model.

11. The video encoder of claim 10, the encoder further comprising a significance-determining unit which determines significance order of the frequency groups by calculating a cost for each of the frequency groups, and arranges the coefficients for each of the frequency groups in a bitstream.

12. The video encoder of claim 11, wherein a frequency group with high significance is put in a front of the bit stream.

13. The video encoder of claim 11, further comprising a flag-setting unit which records a flag indicating frequency-group-partition information in the bitstream.

14. The video encoder of claim 10, wherein the frequency groups comprise a plurality of frequency bands formed in a direction indicated by a diagonal arrow on a plurality of blocks which are divided into a predetermined number.

15. A video decoder comprising:
a coding-pass-selecting unit which selects a coding pass according to a coefficient of a reference block spatially neighboring a current block in order to decode the coefficient of the current block included in at least one quality layer contained in an input bitstream;
a pass-decoding unit which losslessly decodes the coefficient of the current block according to the selected coding pass; and
a frame-decoding unit which restores an image of the current block from the coefficient of the losslessly-decoded current block.

16. The video decoder of claim 15, wherein the coefficient of the current block has the same location as that of the coefficient of the reference block.

17. The video decoder of claim 15, wherein the reference block is a block neighboring a left side or an upper boundary of the current block.

18. The video decoder of claim 15, wherein the pass-decoding unit comprises:
a refinement pass-decoding unit which losslessly decodes the coefficient of the current block according to a refinement pass if the coefficient of the reference block is not 0; and
a significant-pass-coding unit which losslessly decodes the coefficient of the current block according to a significant pass if the coefficient of the reference block is 0.

19. The video decoder of claim 15, wherein the current block and the reference block are 4×4 blocks, 8×8 blocks, or 16×16 blocks.

20. The video decoder of claim 15, further comprising:
a flag-reading unit which reads a flag in order to decode the coefficient of the current block included in the at least one quality layer contained in the input bitstream;
a pass-decoding unit which losslessly decodes the coefficient of the current block according to the coding pass directed by the read flag; and
a frame-decoding unit which restores an image of the current block from the coefficient of the losslessly-decoded current block.

21. The video decoder of claim 20, wherein the current blocks and the reference blocks are 4×4 blocks, 8×8 blocks, or 16×16 blocks.

22. A video decoder comprising:
a flag-reading unit which reads a flag in order to decode a coefficient for a plurality of frequency groups contained in an input bitstream;
an arithmetic-decoding unit which selects context models for each of the frequency groups directed by the read flag and then arithmetically decodes the coefficients for each of the frequency groups according to the selected context models; and
a inverse-scanning unit which inversely arranges the arithmetically-decoded coefficients into a value with respect to respective blocks.

23. The video decoder of claim 22, wherein a plurality of frequency bands are divided according to diagonal directions on a plurality of blocks.

24. The video decoder of claim 22, wherein the blocks are 4×4 blocks, 8×8 blocks, or 16×16 blocks.

25. A video-encoding method comprising:
generating at least one quality layer from an input video frame;
selecting a coding pass according to a coefficient of a reference block spatially neighboring a current block in order to code a coefficient of the current block included in the quality layer; and
coding the coefficient of the current block losslessly according to the selected coding pass.

26. A video-encoding method comprising:
generating at least one quality layer from an input video frame;
coding a current block included in the quality layer losslessly according to a refinement pass;
coding a current block included in the quality layer losslessly according to a significant pass;
calculating a cost of a data losslessly coded according to the refinement pass and a cost of a data losslessly coded according to the significant pass; and
selecting one of the data losslessly coded according to the refinement pass and the data losslessly coded according to the significant pass having a lower calculated cost to be output as a bitstream.

27. A video-encoding method comprising:
generating at least one quality layer from an input video frame;
dividing a plurality of blocks included in the quality layer into at least two frequency groups according to a frequency;
scanning and collecting coefficients included in the frequency groups; and
selecting a context model of the coefficients for each of the frequency groups which are scanned and collected, and then arithmetically coding the coefficients for each of the frequency groups according to the context model.

28. A video decoding method comprising:
selecting a coding pass according to a coefficient of a reference block spatially neighboring a current block in order to code the coefficient of the current block included in at least one quality layer contained in an input bitstream;
decoding the coefficient of the current block losslessly according to the selected coding pass; and
restoring an image of the current block from the coefficient of the losslessly-decoded current block.

29. A video decoding method comprising:
reading a flag in order to decode a coefficient of a current block included in at least one quality layer contained in an input bitstream;
decoding the coefficient of the current block losslessly according to the coding pass directed by the read flag; and
restoring an image of the current block from the coefficient of the losslessly-decoded current block.

30. A video decoding method comprising:
reading a flag in order to decode coefficients for a plurality of frequency groups contained in an input bitstream;
selecting context models for each of the frequency groups directed by the read flag and then arithmetically decoding the coefficients for each of the frequency groups according to the selected context models; and
inversely arranging the arithmetically-decoded coefficients into a value with respect to respective blocks.
